(19) United States
(12) Patent Application Publication
(10) Pub. No.: US 2006/0152782 A1
(43) Pub. Date: Jul. 13, 2006

(54) Optical device, image display apparatus, and head-mounted display

(75) Inventors: Tetsuya Noda, Tenri-shi (JP); Yasushi Tanijiri, Osakasayama-shi (JP); Ichiro Kasai, Toyonaka-shi (JP)

Correspondence Address: SIDLEY AUSTIN LLP, 717 NORTH HARWOOD, SUITE 3400, DALLAS, TX, 75201, US

(73) Assignee: KONICA MINOLTA PHOTO IMAGING, INC.

(21) Appl. No.: 11/292,143

(22) Filed: Dec. 1, 2005

(30) Foreign Application Priority Data
Dec. 3, 2004 (JP) 2004-351706

(51) Int. Cl. G03H 1/00

(52) U.S. Cl. 359/13; 359/14

(57) ABSTRACT

When an optical device is produced by bonding on a transparent base member an optical element formed as a hologram, the optical element and the transparent base member are both formed of an acrylic material. In particular when, as an optical device, an eyepiece optical system is produced by holding an optical element between two transparent base members, the optical element, the transparent base members, and the adhesive with which the transparent base members are joined together are all formed of an acrylic material. In this way, by building an eyepiece optical system with a similar kind of material, namely an acrylic material, it is possible to obtain increased adhesion among the materials of the individual components of the eyepiece optical system without performing special processing. Moreover, the transparent base members formed of an acrylic material more securely absorb shock and external pressure than those formed of glass.

This application is based on Japanese Patent Application No. 2004-351706 filed on Dec. 3, 2004, the contents of which are hereby incorporated by reference.

### BACKGROUND OF THE INVENTION

1. Field of the Invention

The present invention relates to an optical device having a hologram optical element bonded on a transparent base member, relates also to an image display apparatus employing such an optical device, and relates further to a head-mounted display employing such an image display apparatus.

2. Description of Related Art

An optical element such as a hologram, a half-mirror coat, or a beam splitter layer, when used embedded in a transparent base member (held between two transparent base members), is not affected by ambient factors such as humidity and oxygen. Thus, such an optical element is very useful as a combiner in, for example, a head-up display or a head-mounted display.

In general, a head-up display, a hologram screen, or the like is fabricated by using a photopolymer as a hologram photosensitive material and glass as a base member. The reasons are, among others, that, when a photopolymer is used, unlike when a silver halide-based material or gelatin bichromate is used, a hologram can easily be produced by a dry process, and that glass used as the base member is transparent and durable and permits easy fabrication of a large-area, smooth optical surface. However, while a photopolymer is an organic material, glass used as the base ember is an inorganic material, and this results basically in poor adhesion between the two materials.

Methods for increasing adhesion between a hologram and a base member are disclosed, for example, in the following patent publications: Japanese Patent Application Laid-open No. H11-161138 (Patent Publication 1); Japanese Patent Application Laid-open No. H11-161142 (Patent Publication 2); and Japanese Patent Application Laid-open No. H7-234627 (Patent Publication 3).

According to Patent Publication 1, a hologram photosensitive material is mixed with a silane coupler to increase adhesion between the hologram photosensitive material and a glass base member, which is inorganic. According to Patent Publication 2, the surface of a base member is treated with a silane coupler so that the silane coupler increases adhesion between the base member, which is inorganic, and a hologram photosensitive material, which is organic. According to Patent Publication 3, after a hologram photosensitive material is bonded to a base member, these are, before being exposed to laser light, heated to incase adhesion between the hologram photosensitive material and the base member.

However, in a case where the base member to which the hologram photosensitive material is bonded is formed of glass, to increase adhesion between the hologram photosensitive material and the base member, it is necessary, as described above, to perform extra preprocessing, such as preprocessing for mixing the hologram photosensitive material with another substance or special processing for treating the surface of the base member. This makes a hologram optical element difficult to fabricate. Moreover, in a case where a hologram optical element so fabricated is used as a combiner in a head-mounted display, the use of glass as the base material diminishes safety to the eye.

On the other hand, in the method according to Patent Publication 3, the heating performed before the exposure to laser light may cause the monomer contained in the hologram photosensitive material to react before being exposed to laser light, possibly resulting in smaller-than-expected refractive index modulation through laser exposure.

### SUMMARY OF THE INVENTION

In view of the conventionally encountered inconveniences discussed above, it is an object of the present invention to provide an optical device that offers increased adhesion between a hologram photosensitive material and a base member without requiring special processing and that offers higher safety, to provide an image display apparatus incorporating such an optical device, and to provide a head-mounted display incorporating such an image display apparatus.

To achieve the above object, according to one aspect of the present invention, an optical device is characterized in that it is provided with a transparent base member and an optical element formed as a hologram and bonded on the transparent base member, and that the optical element and the transparent base member are both formed of an acrylic material.

With this design, the optical element formed as a hologram and the transparent member to which the optical element is bonded are both formed of a similar kind of material, namely an acrylic material. Thus, it is possible to obtain increased adhesion between the two components without performing special processing on either of them. Moreover, since the transparent base member is formed of an acrylic material, it more securely absorbs shock and external pressure than one formed of glass. Thus, even when an optical device according to the present invention is used as a combiner in a head-mounted display, it offers higher safety to the eye of the observer wearing the head-mounted display.

According to another aspect of the present invention, an image display apparatus is characterized in that it is provided with an optical device according to the present invention as described above and an image display element that displays an image to feed it to the optical device. With this design, the observer can simultaneously observe, via the optical device, the image fed from the image display element and, also via the optical device but here in a see-through fashion, the outside-world image.

According to still another aspect of the present invention, a head-mounted display is characterized in that it is provided with an image display apparatus as described above and a supporter that supports the image display apparatus before an observer's eye. With this design, the image display apparatus is supported before the observer's eye by the supporter, and this permits the observer to observe, with his or her hands free, the outside-world image and the image displayed on the image display element.

### BRIEF DESCRIPTION OF THE DRAWINGS

The above and other objects and features of the present invention will become clear through the following description of preferred embodiments taken in conjunction with the accompanying drawings, in which:

FIG. 1 is a diagram schematically illustrating the production procedure of the eyepiece optical system of the image display apparatus used in a head-mounted display embodying the present invention;

FIG. 2A is a plan view showing an outline of the structure of the above head-mounted display;

FIG. 2B is a side view of the above head-mounted display;

FIG. 2C is a front view of the above head-mounted display;

FIG. 3A is a plan view showing another example of the structure of the above head-mounted display;

FIG. 3B is a side view of the above head-mounted display;

FIG. 3C is a front view of the above head-mounted display;

FIG. 4 is a sectional view showing an outline of the structure of the above image display apparatus;

FIG. 5A is a plan view showing an outline of the structure of one of the two transparent base members that forms the above eyepiece optical system;

FIG. 5B is a front view of the above transparent base member;

FIG. 5C is a plan view showing an outline of the structure of the other transparent base member;

FIG. 5D is a front view of the above transparent base member;

FIG. 5E is a plan view of the above eyepiece optical system;

FIG. 5F is a sectional view of the above two transparent base members forming the above eyepiece optical system, taken around their joint surfaces;

FIG. 6A is a graph showing an example of the diffraction efficiency at different wavelengths in the optical element of the above eyepiece optical system;

FIG. 6B is a graph showing the relationship between the wavelength and light intensity of the light source that feeds light to the above optical element during reproduction; and

FIG. 6C is a graph showing another example of the diffraction efficiency at different wavelengths in the above optical element.

### DETAILED DESCRIPTION OF PREFERRED EMBODIMENTS

Hereinafter, an embodiment of the present invention will be described with reference to the drawings.

1. Head-Mounted Display

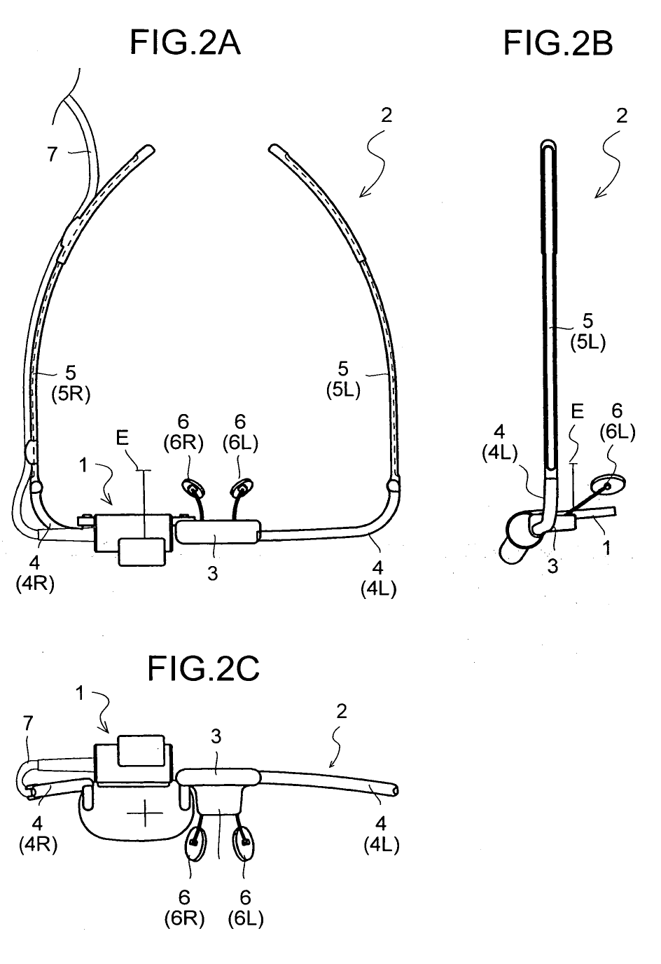

FIG. 2A is a plan view showing an outline of the structure of a head-mounted display (hereinafter abbreviated to “HMD”) embodying the invention, FIG. 2B is a side view of the same HMD, and FIG. 2C is a front view of the same HMD. The HMD includes an image display apparatus 1 and a supporter 2 that supports it, and has an appearance like that of common eyeglasses of which one of the lenses (for example, the left-eye lens) has been removed.

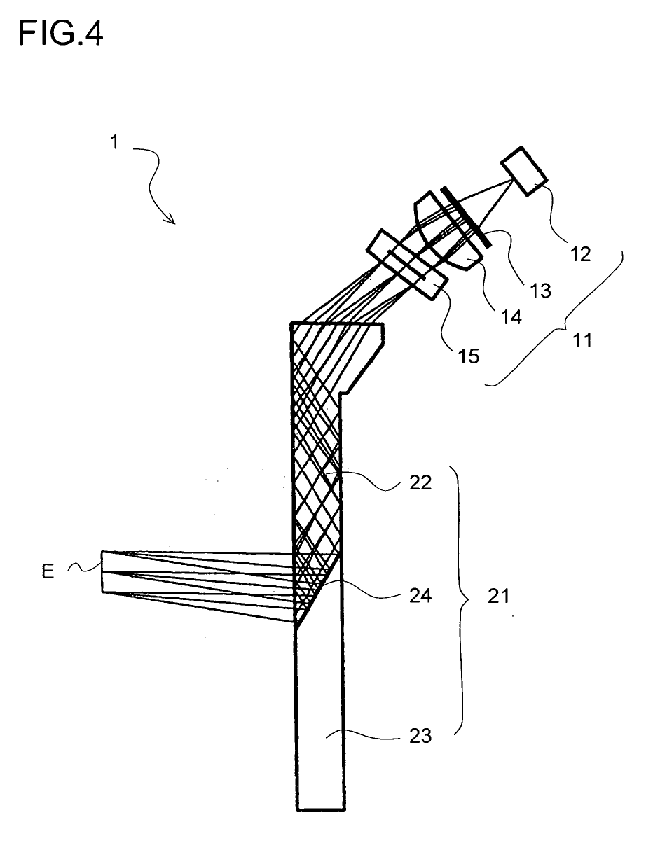

The image display apparatus 1 permits an observer to observe the outside-world image in a see-through fashion, and simultaneously displays an image to feed it, as a virtual image, to the observer. In the image display apparatus 1 shown in FIG. 2C, the part thereof that corresponds to the right-eye lens of eyeglasses is composed of two transparent base members 22 and 23 (see FIG. 4), which will be described later, that are bonded together. The structure of the image display apparatus 1 will be described in detail later.

The supporter 2 supports the image display apparatus 1 before the observer's eye (for example, the right eye), and includes a bridge 3, frames 4, temples 5, nose pads 6, and a cable 7. The frames 4, the temples 5, and the nose pads 6 are provided in pairs each including a left one and a right one and, wherever distinction is necessary, they are referred to as the right frame 4R, the left frame 4L, the right temple 5R, the left temple 5L, the right nose pad 6R, and the left nose pad 6L.

One end of the image display apparatus 1 is supported on the bridge 3. This bridge 3 supports, in addition to the image display apparatus 1, the left frame 4L and the nose pads 6. The left frame 4L pivotably supports the left temple 5L. The other end of the image display apparatus 1 is supported on the right frame 4R. The right frame 4R, at the end thereof opposite to where it supports the image display apparatus 1, pivotably supports the right temple 5R. The cable 7 contains conductors via which external signals (for example, image and control signals) and electric power are fed to the image display apparatus 1, and is laid along the right frame 4R and the right temple 5R.

When an observer uses the HMD, the observer wears it on the head as if to wear common eyeglasses, with the right and left temples 5R and 5L kept in contact with the right and left side parts of the head and the nose pads 6 on the nose. In this state, when the image display apparatus 1 displays an image, the observer can observe, as a virtual image, the image displayed by the image display apparatus 1, and can simultaneously observe the outside-world image in a see-through fashion via the image display apparatus 1.

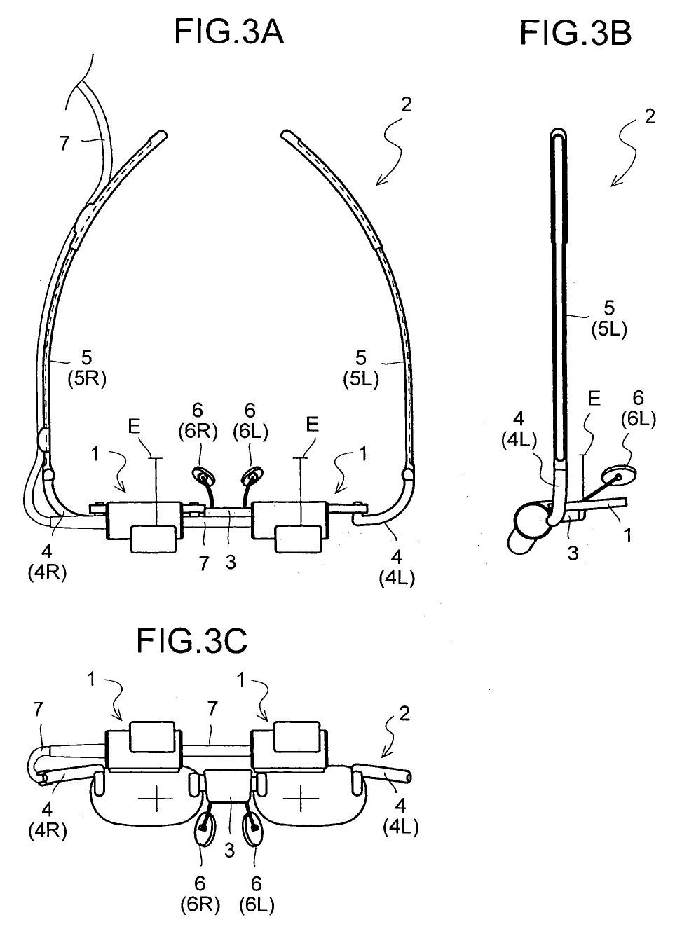

The HMD may be designed otherwise than to include only one image display apparatus 1. For example, FIG. 3A is a plan view showing another example of the structure of the HMD, FIG. 3B is a side view of the same HMD, and FIG. 3C is a front view of the same HMD. As shown in these diagrams, the HMD may have two image display apparatuses 1 arranged one before each eye of an observer. In this case, the image display apparatus 1 arranged before the left eye is supported on the bridge 3 and the left frame 4L in a space secured between them. Moreover, the cable 7 is connected to both the image display apparatuses 1 so that they are both fed with external signals and the like via the cable 7.

2. Image Display Apparatus

Next, the image display apparatus 1 mentioned above will be described in detail. FIG. 4 is a sectional view showing an outline of the structure of the image display apparatus 1. The image display apparatus 1 is composed of an image display element 11 and an eyepiece optical system 21.

The image display element 11 includes a light source 12, a one-directional diffuser plate 13, a condenser lens 14, and an LCD 15. Here, the light source 12, the one-directional diffuser plate 13, and the condenser lens 14 together form an illumination optical system for illuminating the LCD 15.

The light source 12 is built with, for example, an RGB hybrid LED that emits light in three wavelength bands whose center frequencies are 465 nm, 520 nm, and 635 nm. The light source 12 may be a white light source that emits white light.

The one-directional diffuser plate 13 diffuses the illumination light from the one-directional diffuser plate 13 with varying degrees of diffusion in different directions. More specifically, the one-directional diffuser plate 13 diffuses the light incident thereon at about 40 degrees in the direction corresponding to the left/right direction with respect to the observer wearing the HMD (that is, in the direction perpendicular to the plane of FIG. 4) and at about 2 degrees in the direction corresponding to the up/down direction with respect to the observer wearing the HMD (that is, in the direction parallel to the plane of FIG. 4).

The condenser lens 14 condenses the light diffused by the one-directional diffuser plate 13. The condenser lens 14 is so arranged as to permit the diffused light to efficiently form an optical pupil E. The LCD 15 modulates the light incident thereon according to an image signal and thereby displays an image.

The eyepiece optical system 21 includes two transparent base members 22 and 23 and an optical element 24. The eyepiece optical system 21 serves simultaneously as both an optical device that permits the outside-world image to be observed in a see-through fashion via the bonding surfaces of the transparent base members 22 and 23 and an optical devices that directs an enlarged virtual image of the image displayed on the image display element 11 to the observer's eye. The eyepiece optical system 21 has a non-axisymmetric positive optical power so as to satisfactorily correct the aberrations of the image light that has entered it.

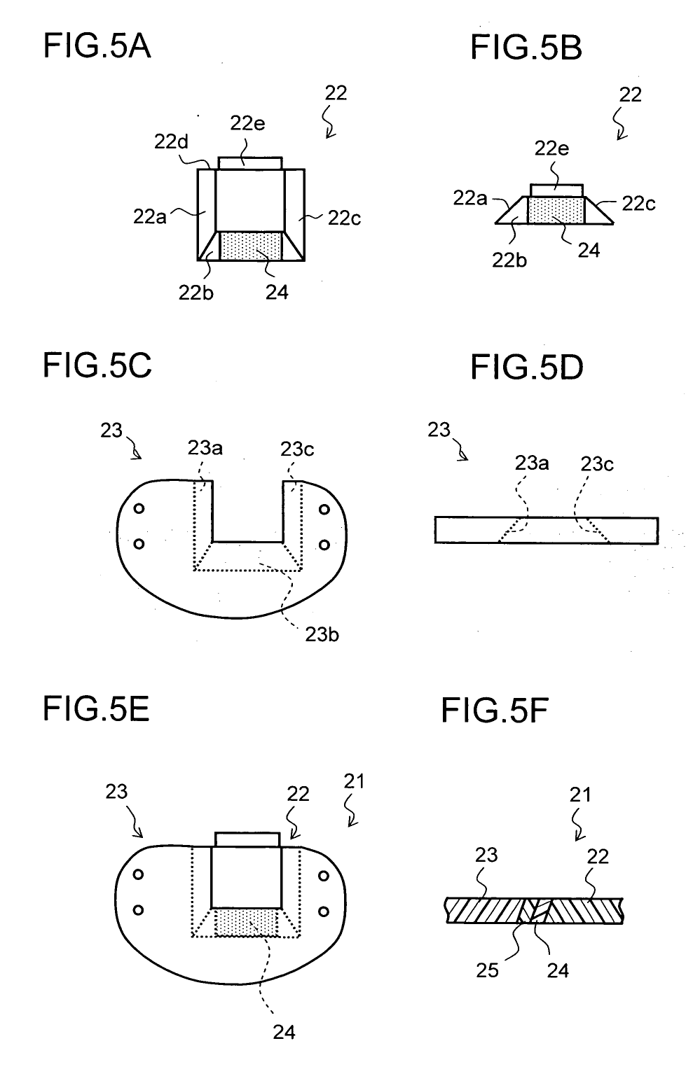

The transparent base members 22 and 23 are formed of, for example, acrylic resin, and are joined together with adhesive 25 (see FIG. 5F). Here, the transparent base member 22 is a plane-parallel plate of which a bottom-end part is made increasingly thin toward the bottom end thereof so as to be shaped like a wedge and of which a top-end part is made increasingly thick toward the top end thereof. The transparent base member 23 is a plane-parallel plate of which a top-end part is so shaped as to fit the bottom-end portion of the transparent base member 22 so that the transparent base members 22 and 23 together form substantially a plane-parallel plate.

If the transparent base members 22 and 23 are not joined together, the light of the outside-world image is refracted when it passes the wedge-shaped bottom-end portion of the transparent base member 22. This produces distortion in the outside-world image observed via the transparent base member 22. By contrast, when the transparent base members 22 and 23 are joined together so as to together form substantially a plane-parallel plate, the refraction that the light of the outside-world image undergoes when it passes through the wedge-shaped bottom-end part of the transparent base member 22 is cancelled with the transparent base member 23. This helps prevent distortion from being produced in the outside-world image observed in a see-through fashion.

The optical element 24 is built with a volume-phase-type reflective hologram that diffracts light in three wavelength bands of, for example, 465±10 nm, 520±10 nm, and 635±10 nm that is incident thereon at a prescribed angle of incidence. The optical element 24 is bonded to the slanted surface of the bottom-end portion of the transparent base member 22, and thus the optical element 24 is held between the transparent base members 22 and 23. The transmittance of the optical element 24 is set to be 10% or more.

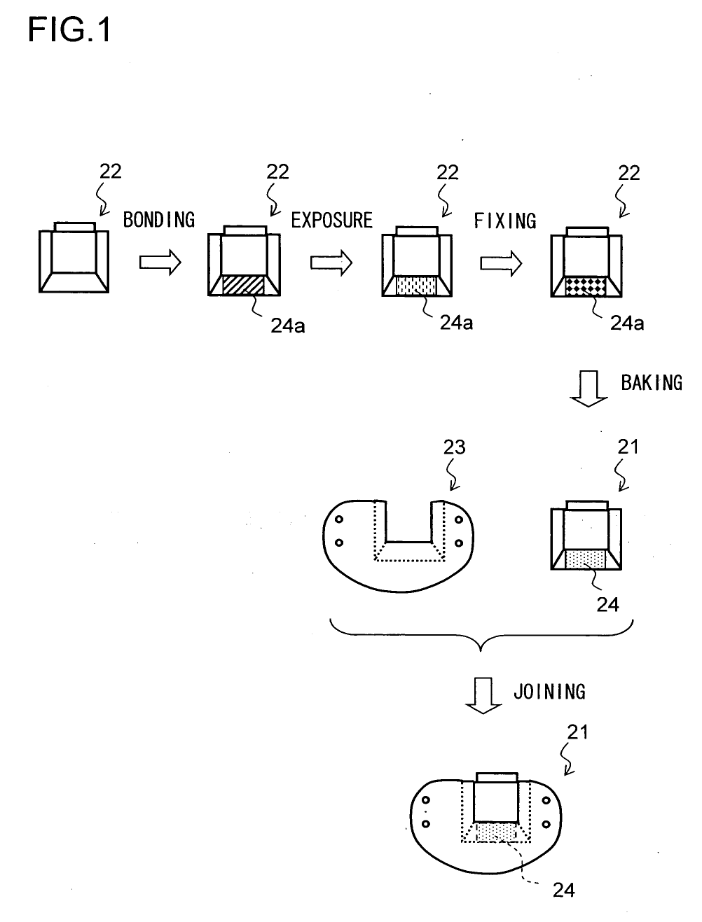

The optical element 24 is formed of a hologram photosensitive material 24a (see FIG. 1) such as a photopolymer, a silver-halide-based material, or gelatin bichromate. Among the just mentioned materials, a photopolymer is particularly preferable because it can be produced by a dry process.

In the image display apparatus 1 structured as described above, the light emitted from the light source 12 of the image display element 11 is diffused by the one-directional diffuser plate 13, is then condensed by the condenser lens 14, and is then incident on the LCD 15. The light incident on the LCD 15 is modulated according to an image signal, and then exits, as an image light, from the LCD 15. Here, the LCD 15 displays an image itself.

The image light from the LCD 15 enters the transparent base member 22 of the eyepiece optical system 21 via the top-end surface thereof, and is then totally reflected a plurality of times on the mutually opposite surfaces thereof so as to be incident on the optical element 24. The light incident on the optical element 24 is reflected thereon so as to reach the optical pupil E. At the position of the optical pupil E, the observer observes an enlarged virtual image of the image displayed on the LCD 15. The distance from the optical pupil E to the virtual image is about several meters, and the size of the virtual image is ten or more times as large as the image displayed on the LCD 15.

On the other hand, the transparent base members 22 and 23 and the optical element 24 transmit most of the light from the outside world, and thus permit the observer to observe the outside-world image. Thus, the virtual image of the image displayed on the LCD 15 is observed overlaid on part of the outside-world image. As will be understood from the foregoing, the optical element 24 can be said to function as a combiner that simultaneously directs the image formed by the image display element 11 and the outside-world image to the observer's eye.

As described above, the image display apparatus 1 is so structured that the image light exiting from the LCD 15 is directed to the optical element 24 by being totally reflected within the transparent base member 22. This makes it possible to arrange the image display element 11 far away from immediately before the observer's eye, and thereby permits the observer to observe the outside world via a wide field of view. Moreover, it is possible to make the transparent base members 22 and 23 as thin as about 3 mm, like common eyeglass lenses, and thereby to make the image display apparatus 1 compact and lightweight.

Moreover, since the optical element 24 diffracts only light of prescribed wavelengths that is incident thereon at a prescribed angle of incidence, it does not affect the light of the outside-world image that is transmitted through the transparent base members 22 and 23 and the optical element 24. Thus, the observer can as usual observe the outside-world image via the transparent base members 22 and 23 and the optical element 24. Moreover, since the transmittance of the optical element 24 is set to be 10% or more, the observer can observe the outside-world image sufficiently clearly via the transparent base members 22 and 23 and the optical element 24.

3. Transparent Base Members

Next, the transparent base members 22 and 23 will be described in detail. FIG. 5A is a plan view of the transparent base member 22 (the first transparent base member), and FIG. 5B is a front view of the transparent base member 22. FIG. 5C is a plan view of the transparent base member 23 (the second transparent base member), and FIG. 5D is a front view of the transparent base member 23. FIG. 5E is a plan view of the eyepiece optical system 21 having the transparent base members 22 and 23 joined together. FIG. 5 is a sectional view of the transparent base members 22 and 23, taken around the joint surfaces thereof.

The transparent base member 22 as a whole has the shape of a truncated rectangular pyramid, with the top and bottom surfaces thereof joined by four side surfaces. These four side surfaces are surfaces 22a, 22b, 22c, and 22d located counter-clockwise around the top surface. These surfaces 22a, 22b, 22c, and 22d are so oriented that the lines normal thereto point in mutually different directions. One of these surfaces (for example, the surface 22d) has part thereof formed into a protruding portion 22e that protrudes upward from the top surface. The optical element 24 is bonded to, for example, the surface 22b of the transparent base member 22.

On the other hand, the transparent base member 23 is so shaped that, when the transparent base member 22 is joined thereto, they together form a plane-parallel plate. That is, the transparent base member 23 has the shape of a plane-parallel plate from which the shape of the transparent base member 22 has been removed. Here, the surfaces of the transparent base member 23 that face the surfaces 22a, 22b, and 22c of the transparent base member 22 when the transparent base members 22 and 23 are joined together are called the surfaces 23a, 23b, and 23c, respectively. These surfaces 23a, 23b, and 23c are so oriented that the lines normal thereto point in mutually different directions.

In this way, to one transparent base member 22 having the optical element 24 bonded thereto, the other transparent base member 23 is joined with the adhesive 25 so that the optical element 24 is held in between, and thereby the eyepiece optical system 21 shown in FIG. 5E is formed. Seen in a plan view, the eyepiece optical system 21 is shaped like an eyeglass lens. With this eyepiece optical system 21, the outside-world image can be observed in a see-through fashion via the joint surfaces (the surfaces 22a, 22b, 22c, 23a, 23b, and 23c) of the transparent base members 22 and 23.

4. Production Procedure of the Eyepiece Optical System

Next, the production procedure of the eyepiece optical system 21 as an optical device will be described. The production procedure of the eyepiece optical system 21 involves the following five processes: a bonding process, an exposure process, a fixing process, a baking (heat treatment) process, and a joining process. If the production of the eyepiece optical system 21 through these processes is called “fabrication” of the optical element 24, the use of the thus fabricated optical element 24 in various devices can be called “reproduction” thereof. Now, the above-mentioned production procedure will be described in detail with reference to FIG. 1.

First, on one transparent base member 22 to be used during reproduction, a hologram photosensitive material 24a, for example a photopolymer, is bonded (the bonding process). Then, by two-beam interference of laser light, the hologram photosensitive material 24a on the transparent base member 22 is exposed (the exposure process). Subsequently, the hologram photosensitive material 24a is irradiated with ultraviolet rays so as to be fixed (the fixing process).

Then, the hologram photosensitive material 24a bonded on the transparent base member 22 is baked to form a hologram (the optical element 24) with high diffraction efficiency. Then, lastly, on the surface of the transparent base member 22 at which it will be joined to the other transparent base member 23, ultraviolet-curing adhesive, which is a kind of light-curing adhesive, is applied as the adhesive 25 (see FIG. 5F), and is then irradiated with ultraviolet rays so as to be cured. Thus, the transparent base members 22 and 23 are joined together with the hologram photosensitive material 24a (optical element 24) held between them (the joining process). In this way, the eyepiece optical system 21 is formed.

Incidentally, the reason that the diffraction efficiency of the hologram increases in the baking process is as follows. Exposing the hologram photosensitive material 24a produces interference fringes, forming high- and low-refractive-index portions in the hologram. However, since the photopolymer used as the hologram photosensitive material 24a is a polymer material, simply exposing it does not provide a sufficiently large difference in refractive index between the high- and low-refractive-index portions. Here, conveniently, when heat is applied to the hologram photosensitive material 24a in the baking process, unreacted monomers and the like in the hologram photosensitive material 24a are diffused by the heat, producing a large difference in density. This increases the difference in refractive index within the hologram, and thus increases the diffraction efficiency thereof.

The baking process may be performed after the joining process. In that case, part of the adhesive 25 that remains uncured after joining may adversely affect the hologram layer. For this reason, it is preferable that, as in the embodiment under discussion, baking be completed before joining.

5. Details of the Eyepiece Optical System

In the embodiment under discussion, when the eyepiece optical system 21 is produced, the hologram photosensitive material 24a and the transparent base members 22 and 23 are formed of an acrylic material. Specifically, the hologram photosensitive material 24a is formed of a material containing many acrylate derivatives such as polymethyl methacrylate (PMMA), methacrylate, phenoxyethyl acrylate, chlorophenyl acrylate triethyleneglycol diacrylate, and trimethylolpropane trimethacrylate (an example of such a material includes “OmniDex” manufactured by DuPont). On the other hand, the transparent base members 22 and 23 are formed of metyacrylic resin such as polymethyl methacrylate (PMMA) (examples of such materials include “ACRYPET” manufactured by Mitsubishi Rayon Co., Ltd, “Zeonex” manufactured by Nippon Zeon Co., Ltd., and “Delpet” manufactured by Asahi Kasei Corporation.

When acrylic materials are used as the hologram photosensitive material 24a, that is, the material of the optical element 24, and as the material of the transparent base member 22 to which the hologram photosensitive material 24a is bonded, higher adhesion is obtained between the hologram photosensitive material 24a and the transparent base member 22 than when those are formed of different kinds of material. Thus, without performing special processing as by adding another substance to the hologram photosensitive material 24a or treating the surface of the transparent base member 22 as conventionally practiced, it is possible to obtain increased adhesion between them.

An acrylic material used as the hologram photosensitive material 24a provides excellent properties as a hologram material; specifically, it exhibits high polymerization reactivity (in terms of reaction rate and exposure sensitivity) during laser exposure in the exposure process, and exhibits quick refractive index change after laser exposure. This makes it possible to record interference fringes in a short time, and thus helps avoid the influence of ambient factors such as vibration. In addition, the thus recorded hologram provides a large difference in refractive index, making it possible to fabricate a hologram with excellent properties such as high diffraction efficiency.

On the other hand, the transparent base members 22 and 23 have properties such as being highly transparent and being easily moldable by injection molding or the like, and thus offers excellent properties as an optical base material. In addition, the transparent base members 22 and 23 are inexpensive and lightweight, and more securely absorbs shock and external pressure than glass. Thus, even when the eyepiece optical system 21 is built with the transparent base members 22 and 23 and is used as a combiner in the HMD as in this embodiment, it is possible to achieve high safety to the observer's eye.

As discussed above, in the production of the eyepiece optical system 21, using acrylic materials as both the hologram photosensitive material 24a and the transparent base members 22 and 23 is extremely effective, because doing so offers not only increased adhesion but may other advantages.

Moreover, in this embodiment, since the eyepiece optical system 21 is formed by joining the transparent base member 22 to the other transparent base member 23 formed of an acrylic material with the optical element 24 held between them, the eyepiece optical system 21 can easily be used as a combiner in the HMD.

Here, it is preferable that the adhesive 25 used to join the transparent base members 22 and 23 together be formed of an acrylic material. Examples of such adhesives include those containing an acrylate derivative such as an acrylic denatured oligomer, tetrahydrofurfuryl methacrylate, substituted ethyl acrylate, substituted urethane acrylate (for example, “LCR0628A” manufactured by Toagosei Co., Ltd. and “NOA 76” manufactured by Norland Products Inc.).

In general, the adhesion (bonding strength) of a material is higher against a material of a similar kind than against one of a different kind. Thus, when the hologram photosensitive material 24a and the transparent base members 22 and 23 are both formed of an acrylic material, if an acrylic material is used also as the adhesive 25, it is naturally possible to obtain higher adhesion.

It is preferable that the adhesive 25 used to join the transparent base members 22 and 23 together be, among different kinds of acrylic adhesive, of an ultraviolet-curing type. An ultraviolet-curing adhesive has a low contraction coefficient, and thus its use helps minimize deformation of and damage to the optical element 24 and the transparent base members 22 and 23. Moreover, unlike a thermosetting adhesive, an ultraviolet-curing adhesive does not require heat to cure, and thus its use helps prevent deformation of the transparent base members 22 and 23 under heat. Furthermore, an ultraviolet-curing adhesive of a type that contains no solvent is used to prevent the optical element 24 from being adversely affected by a solvent.

In this embodiment, the optical element 24 is formed by bonding the hologram photosensitive material 24a in an unexposed state to the transparent base member 22 to be used during reproduction and then exposing it to laser light. This, as compared with a procedure involving re-bonding of the optical element 24 after laser exposure to the transparent base member to be used during reproduction, not only requires less fabrication processes and thus contributes to higher productivity, but also offers the following various advantages. There is no need to use adhesive for re-bonding, and therefore the optical element 24 is prevented from being adversely affected by adhesive. There is no likeliness of the optical element 24 being re-bonded into a deviated position. Even if the surface accuracy of the transparent base member 22 is slightly deviated from what it should ideally be, the optical element 24 can be fabricated by performing exposure with the deviation taken into consideration. Thus, it is possible to eliminate or minimize the influence of the deviation of the surface accuracy of the transparent base member 22.

Moreover, since the hologram photosensitive material 24a in an unexposed state is bonded to the transparent base member 22 to be used during reproduction and is then exposed to laser light to fabricate an optical device having a hologram recorded thereon, the polymerization reaction of the hologram photosensitive material 24a during exposure and the subsequent polymerization reaction during fixing permit the surface 22a to adhere firmly on the transparent base member 22. This effect is augmented by the fact that the hologram photosensitive material 24a and the transparent base member 22 are formed of similar kinds of material (acrylic materials). The hologram photosensitive material 24a in an unexposed state is bonded, by its own adhesion, to the transparent base member 22, but it loses its adhesion after exposure. Thus, the optical element 24 can be said to be bonded to the transparent base member 22 through the polymerization reaction that takes place in the exposure process in which the hologram photosensitive material 24a is exposed to laser light and in the fixing process in which the hologram photosensitive material 24a is fixed by being irradiated with light.

In a long run, during reproduction, the optical element 24 formed as a hologram slightly deteriorates and becomes yellowish under ultraviolet rays. To avoid this, for example, an ultraviolet absorber is added to the transparent base members 22 and 23 formed of an acrylic material so that they reduce the ultraviolet rays that reach the optical element 24. To alleviate the deterioration and yellowing of the optical element 24 under ultraviolet rays as just described, it is preferable that the spectral transmittance of the transparent base members 22 and 23 at a wavelength of 360 nm be 10% or less. This applies also when the transparent base members 22 and 23 contain no ultraviolet absorber.

Adding too much ultraviolet absorber to the transparent base members 22 and 23 makes them appear yellowish by themselves. This is undesirable not only because of the resulting poor appearance, considering that this embodiment is actually used with the eyepiece optical system 21 as a combiner located before the eye, but also because the observer then cannot properly recognize the colors of the outside-world image observed in a see-through fashion via the eyepiece optical system 21 (that is, the see-through property degrades). To avoid this by keeping the transparent base members 22 and 23 transparent and obtaining a satisfactory see-through property, it is preferable that the spectral transmittance of the transparent base members 22 and 23 at a wavelength of 400 nm be set to be 80% or more, and that the content of the ultraviolet absorbent be so reduced as to achieve such a spectral transmittance.

It is alternatively possible to reduce the deterioration and yellowing of the transparent base members 22 and 23 by eliminating light in the ultraviolet region from the light emitted from the light source used during reproduction.

Baking the hologram photosensitive material 24a after it has been exposed to laser light helps increase the diffraction efficiency of the optical element 24. This is because, as described previously, heating permits unreactd monomers contained in the hologram photosensitive material 24a to diffuse and move. Accordingly, it is preferable that the refractoriness-under-load temperature (deflection temperature under load) of the transparent base member 22 be as high as possible, and at least higher than or equal to the temperature that permits unreacted monomers contained in the hologram photosensitive material 24a to diffuse and move within the hologram photosensitive material 24a. Here, the refractoriness-under-load temperature denotes the temperature at which the transparent base member 22 softens (deforms) under load.

In this embodiment, the refractoriness-under-load temperature of the transparent base member 22 is set to be about 20° C. or more higher than the temperature that permits unreacted monomers to diffuse and move. The temperature that permits unreacted monomers to diffuse and move varies from one type of hologram photosensitive material 24a to another. In a case where, for example, “OmniDex” manufactured by DuPont is used, it is advisable to use, as the transparent base member 22, one having a refractoriness-under-load temperature of 100° C. or higher. Using such a transparent base member 22 makes it possible to avoid deformation of the transparent base member 22 in the baking process while simultaneously permitting unreacted monomers to diffuse so as to increase the local difference in refractive index and thereby increase diffraction efficiency. Moreover, since deformation of the transparent base member 22 can be prevented, it is possible to obtain satisfactory surface accuracy.

The wavelength (reproduction wavelength) of the light (reproduction light) that exits from the optical element 24 during reproduction is determined by the wavelength of the laser light to which the hologram photosensitive material 24a is exposed during fabrication. Accordingly, to obtain single-color reproduction light during reproduction, it is necessary to expose the hologram photosensitive material 24a to laser light of at least one color. To obtain colored reproduction light during reproduction, it is necessary to expose the hologram photosensitive material 24a to laser light of a plurality of wavelengths corresponding to necessary colors. From the perspective of enjoying images, colored reproduction is preferable, and accordingly, in this embodiment, the hologram photosensitive material 24a is exposed to laser light of three wavelengths corresponding to red (R), green (G), and blue (B) during fabrication so that color images (reproduced images) are obtained during reproduction.

Here, to obtain bright colored reproduced images, the diffraction efficiency of the optical element 24 needs to be increased at each of the three, namely R, G, and B, wavelengths. The diffraction efficiency indicates what portion of the energy of incident light can be extracted as the energy of diffracted light, and is generally expressed by the ratio, as given in percentage, of the intensity of diffracted light of a particular order to the intensity of incident light.

With an optical element 24 that has a diffraction peak for only one color (a peak in diffraction efficiency), that is, only one diffraction peak, it is in principle impossible to obtain diffraction efficiency of 100% or higher. By contrast, with a color hologram that diffracts light at a plurality of wavelengths (diffraction wavelengths), diffraction peaks exist one for each of the different wavelengths, and thus it is possible, for example, to make the sum of the diffraction efficiency at those different wavelengths equal to or higher than 100%.

Specifically, in this embodiment, the optical element 24 is so fabricated that it has a plurality of diffraction peaks corresponding to a plurality of wavelengths (RGB) and that the sum of the diffraction efficiency at those peaks is equal to or higher than 100%. Such a optical element 24 can be realized by, during its fabrication, exposing the hologram photosensitive material 24a to RGB laser light and then increasing the diffraction efficiency for each color in the baking process.

When the eyepiece optical system 21 incorporating the above optical element 24 is used as a combiner in the HMD, and a color image is displayed on the image display apparatus 1 of the HMD, the observer can observe, as a virtual image, a bright color image via the optical element 24. Moreover, the light from the light source 12 (reproduction light source) used during reproduction can be effectively used. Moreover, since the wavelengths at which the individual diffraction peaks are located are the wavelengths corresponding to the individual R, G, and B colors, it is possible to present the observer with, as a virtual image, a color image with high color purity and a wide color reproduction range.

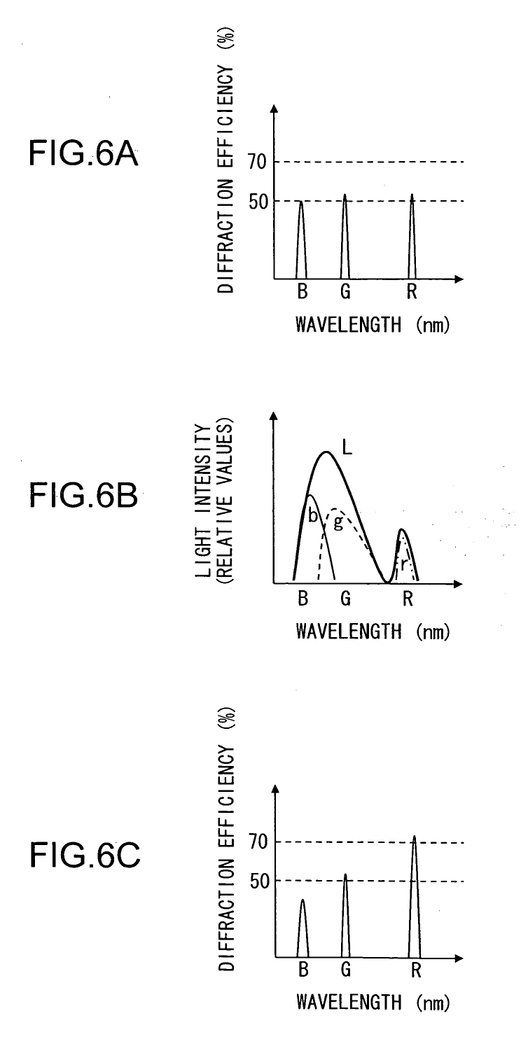

Ideally, the diffraction efficiency at the diffraction peak of each of the R, G, and B wavelengths is 100% at the maximum, and therefore, ideally, its sum equals 100% multiplied by the number of diffraction peaks. In reality, however, the hologram photosensitive material 24a is sensitive to laser light at a plurality of wavelengths, and the sensitivity at those different wavelengths affect one another, making it difficult to obtain the maximum diffraction efficiency of 100% at all the diffraction peaks. In fact, the diffraction efficiency at the diffraction peak of each of the wavelengths is, for example, about several tens percent (for example, about 50% at each of the R, G, and B wavelengths as shown in FIG. 6A). Even then, it is still possible to make the sum of the diffraction efficiency at the diffraction peaks of the different wavelength equal to or higher than 100% (in the example shown in FIG. 6A, 150% or higher).

To obtain satisfactory color display, it is necessary to strike a proper brightness balance (color balance) among the different colors (RGB). In a simplified form, the brightness of an image is calculated as the sum of the “diffraction efficiency multiplied by the intensity of illumination light (reproduction light) at the same wavelength as that of diffracted light (diffraction wavelength)” for the different colors. A proper color balance in the image is achieved by adjusting the values of the just mentioned “diffraction efficiency multiplied by the intensity of illumination light at the same wavelength as that of diffracted light” for the different colors so that those values are in a prescribed ratio that produces satisfactory white display. Accordingly, in reality, the just mentioned ratio takes a fixed value that varies with the diffraction wavelength. That is, to obtain satisfactory color display, the diffraction efficiency at the different diffraction wavelengths needs to be set in consideration of the intensity of illumination light at the same wavelengths as those diffraction wavelengths, respectively.

For example, suppose that, in the optical element 24 that produces diffracted light of three, namely R, G, and B, colors, the diffraction efficiency for those three colors is approximately equal as shown in FIG. 6A. Suppose also that, when this optical element 24 is illuminated with an illumination light source (the light source 12 as a reproduction light source), the intensity of R light is insufficient to obtain white display. In this case, it is advisable to make the diffraction efficiency for R light higher than that for other light as shown in FIG. 6C.

In FIG. 6B, the curves “r”, “g”, and “b” represent the intensity of R, G, and B light, respectively, and the curve “L” represents the overall intensity of R, G, and B light. Here, the light intensity is plotted, for example, in terms of intensity relative to that of B light.

As discussed above, by adjusting the balance of the amounts of R, G, and B diffracted light so as to obtain white display, it is possible to obtain satisfactory color display. From the perspectives of the brightness of the image and efficient use of the light of the reproduction light source, it is advisable to fabricate (in particular, bake) the optical element 24 so that, as shown in FIG. 6C, the maximum value of the diffraction efficiency among those at the different wavelengths (R, G, and B) at which the diffraction efficiency has a peak, is 70% or higher.

As described above, the diffraction efficiency of the hologram photosensitive material 24a increases in the baking process (its sensitivity is increased). On the other hand, in this embodiment, the transparent base member 22 is formed of an acrylic material, which is not highly resistant to heat. For this reason, if the hologram photosensitive material 24a is baked at a baking temperature of 100° or higher as commonly practiced, the transparent base member 22 deforms. Thus, the hologram photosensitive material 24a cannot be baked at the just mentioned baking temperature. However, if the hologram photosensitive material 24a is not baked at all, it is not possible to “make the sum of the diffraction efficiency for R, G, and B light equal to or higher than 100%”, nor is it possible to “make the maximum value of the diffraction efficiency among those for R, G, and B color equal to or higher than 70%”.

Thus, in the structure of this embodiment where the transparent base member 22 is formed of an acrylic material, the basing process is performed under milder conditions. That is, it is advisable to bake the hologram photosensitive material 24a at a lower temperature but for a longer period.

Specifically, it is advisable to perform baking at a temperature equal to or lower than the refractoriness-under-load temperature of the transparent base member 22. To obtain the effect of baking efficiently in a short period, the higher the baking temperature, the better. For example, let the refractoriness-under-load temperature be T ° C., then it is advisable to perform baking at a baking temperature (° C.) of
T−Δ

(where Δ is one of the values 5, 10, 15, 20, 25, and 30).

Thus, when the transparent base member 22 is formed of an acrylic material of a common grade, though depending on the heat resistance of the acrylic material, the typical baking temperature is 100° or lower, fulfilling the above formula. Needless to say, when the transparent base member 22 is formed of an acrylic material with higher heat resistance, the baking temperature as calculated based on the above formula is 100° C. or higher, and thus the baking process can be performed at a temperature of 100° C. or higher.

In this embodiment, the eyepiece optical system 21 has been described as having the optical element 24 held between the transparent base members 22 and 23. Needless to say, the structure of this embodiment may be applied also in a case where the optical device is so structured as to have the optical element 24 simply bonded on the transparent base member 22. In this case, there is no need to use adhesive 25 as used in this embodiment to join the transparent base members 22 and 23 together, and thus it is possible to prevent the optical element 24 from being adversely affected by adhesive 25.

In this embodiment, the transparent base members 22 and 23 have been described as having flat joint surfaces. Instead, the joint surfaces may be, for example, curved.

In this embodiment, the image display apparatus 1 has been described as being applied to an HMD. Instead, it may be applied to, for example, a head-up display.

In this embodiment, the transparent base members 22 and 23 have been described as being flat-plate-shaped. Instead, they may have curvatures. In that case, the eyepiece optical system 21 can function as an eyeglass lens for correcting the dioptric power of the eye.

As described above, according to the present invention, an optical device is produced by bonding an optical element formed as a hologram on a transparent base member, and the optical element and the transparent base member are both formed of an acrylic material.

Thus, without performing special processing on either of the optical element and the transparent base member, it is possible to obtain increased adhesion between them. Moroever, since the transparent base member is formed of an acrylic material, even when the optical device of the present invention is used as a combiner in a head-mounted display, it is possible to achieve higher safety to the eye of the observer wearing the head-mounted display. Furthermore, advantageously, the optical element formed of an acrylic material offers excellent properties (in terms of sensitivity, refractive index change, etc.) as a hologram, and the transparent base member formed of an acrylic material offers high transmittance, is easy to old, and offers excellent properties as an optical base member.

The above transparent base member may be joined to another transparent base member so that the above optical element is held in between. In that case, the optical device according to the present invention can easily be applied as a combiner in a head-mounted display. Moreover, in such a head-mounted display, the distortion produced in the light of the outside-world image when it passes through one transparent base member can be cancelled with the other transparent base member, and thus it is possible to prevent the outside-world image from being distorted.

It is preferable that the transparent base members be joined together with adhesive formed of an acrylic material. In that case, the optical element, the transparent base members, and the adhesive are all formed of similar kinds of material, namely acrylic materials. Thus, even with a structure where the transparent base members are joined together with adhesive, higher adhesion is obtained between them.

Here, it is preferable that the adhesive is of a ultraviolet-curing type. An ultraviolet-curing adhesive has a low contraction coefficient, and thus its use helps minimize deformation of and damage to the optical element and the transparent base members. Moreover, unlike a thermosetting adhesive, an ultraviolet-curing adhesive does not require heat to cure, and thus its use helps prevent deformation of the transparent base members under heat. Furthermore, an ultraviolet-curing adhesive of a type that contains no solvent is used to prevent the optical element 24 from being adversely affected by a solvent.

It is preferable that the optical element be formed by bonding a hologram photosensitive material (formed of an acrylic material) in an unexposed state to the transparent base member to be used during reproduction and then exposing it to laser light. Here, “reproduction” denotes occasions on which the fabricated optical element is used in various devices. That is, using the optical element “during reproduction” is a different concept from using it “during fabrication”.

This structure, where the hologram photosensitive material in an unexposed state is bonded to the transparent base member to be used during reproduction and is then exposed to laser light, as compared with a structure where the optical element after laser exposure is re-bonded to the transparent base member to be used during reproduction, requires less fabrication processes and thus contributes to higher productivity. Moreover, There is no need to use adhesive for re-bonding, and therefore the optical element is prevented from being adversely affected by adhesive. Furthermore, there is no likeliness of the optical element being re-bonded into a deviated position. In this way, many advantages are obtained.

It is preferable that the optical element be bonded to the transparent base member through the polymerization reaction that takes place in the exposure process in which the hologram photosensitive material (formed of an acrylic material) is exposed to laser light and in the fixing process in which the hologram photosensitive material is fixed by being irradiated with light. (for example, ultraviolet rays). The hologram photosensitive material in an unexposed state is bonded by its own adhesion. However, by exploiting the polymerization reaction that takes place in the exposure and fixing processes in this way, it is possible to more firmly join the hologram photosensitive material and the transparent base member together.

It is preferable that the spectral transmittance of the transparent base member at a wavelength of 360 nm be 10% or less. In that case, ultraviolet rays in a short-wavelength region are mostly absorbed by the transparent base member. In the long run, the optical element slightly deteriorates and become yellowish under ultraviolet rays. With the above structure, however, it is possible to prevent deterioration of the optical element.

It is preferable that the spectral transmittance of the transparent base member at a wavelength of 400 nm be 80% or more. In that case, it is possible to make the transparent base member satisfactorily transparent and thereby obtain a satisfactory see-through property.

It is preferable that the refractoriness-under-load temperature of the transparent base member be set to be equal to or higher than the temperature that permits unreacted monomers in the hologram photosensitive material to diffuse and move within the hologram photosensitive material. Here, the refractoriness-under-load temperature denotes the temperature at which the transparent base member softens (deforms) under load. In that case, it possible to avoid deformation of the transparent base member in the baking process while simultaneously permitting unreacted monomers to diffuse so as to increase the local difference in refractive index and thereby increase diffraction efficiency. Moreover, since deformation of the transparent base member can be prevented, it is possible to obtain satisfactory surface accuracy.

It is preferable that the optical element have a plurality of diffraction efficiency peaks corresponding to a plurality of wavelengths, and that the sum of the diffraction efficiency at the wavelengths at which the diffraction efficiency has peaks be 100% or more. In that case, for example, when an image from an image display element is presented as a virtual image to an observer via the optical device according to the present invention, it is possible to present, as the virtual image, a bright color image. Moreover, it is also possible to more efficiently use the light of the light source of the image display element.

Here, it is preferable that the plurality of wavelengths be those corresponding to red (R), green (G), and blue (B) colors, respectively. In that case, with the R, G, and B colors, it is possible to obtain a color image with high color purity and a wide color reproduction rage.

It is preferable that the maximum value of the diffraction efficiency among those at the wavelengths at which the diffraction efficiency has peaks be 70% or more. In that case, it is possible to obtain a bright image, and to use the light of the light source highly efficiently.

According to the present invention, an image display apparatus is provided with the above-described optical device according to the present invention and an image display element that displays an image to feed it to the optical device. With this structure, the observer can observe, via the optical device, the image fed from the image display element and simultaneously observe, also via the optical device but here in a see-through fashion, the outside-world image.

Here, it is preferable that the optical element included in the optical device be a volume-phase-type reflective hologram In that case, by making the hologram reflect the image light fed from the image display element toward the observer, it is possible to permit the observer to observe a virtual image. In addition, since a volume-phase-type reflective hologram exhibits high transmittance to the light of the outside-world image, the observer can observe the outside-world image clearly.

The optical element included in the optical device may be a combiner that directs the image fed from the image display element and the outside-world image simultaneously to the observer's eye. In that case, via the optical element, the observer can observe the image fed from the image display element and the outside-world image.

The optical device may form an eyepiece optical system that directs an enlarged virtual image of the image displayed on the image display element to the observer's eye. In that case, the observer can satisfactorily clearly observe, as a virtual image, the image displayed on the image display element. Moreover, since the eyepiece optical system presents the observer with, as a virtual image, the image displayed on the image display element, it is possible to make the optical device forming the eyepiece optical system compact and lightweight, and thus to make the image display apparatus compact and lightweight.

It is preferable that the eyepiece optical system have a non-axisymmetric (positive) optical power. In that case, even when the eyepiece optical system is made compact, it is possible to present the observer with an image with satisfactorily corrected aberrations.

It is preferable that the transparent base member of the optical device be so structured as to totally reflect within itself the light of the image fed from the image display element to direct it to the optical element. With this structure, it is possible to efficiently use the image light fed from the image display element and thereby present the observer with a bright image. Moreover, it is possible to arrange the image display element away from the optical device, and thus to permit the observer to observe the outside world via a wide field of view.

It is preferable that the transmittance of the optical element of the optical device be 10% or more. In that case, even via the optical element, the observer can observe the outside-world image satisfactorily clearly in a see-through fashion.

According to the present invention, a head-mounted display is provided with the above-described image display apparatus and a supporter that supports the image display apparatus before an observer's eye. With this structure, since the image display apparatus is supported before the observer's eye by the supporter, the observer has his or her hands free, and can thus observe the outside-world image and, as a virtual image, the image displayed on the image display element while doing handwork with his or her free hands. Moreover, the observation direction of the observer is fixed in one direction, and therefore, advantageously, the observer can easily find the displayed ed image even in a dark environment.

Obviously, many modifications and variations of the present invention are possible in light of the above teachings. It is therefore to be understood that within the scope of the appended claims, the invention may be practiced other than as specifically described.

What is claimed is:

1. An optical device comprising:
a transparent base member; and
an optical element formed as a hologram and bonded on the transparent base member,
wherein the optical element and the transparent base member are both formed of an acrylic material.

2. The optical device of claim 1,
wherein the transparent base member is joined to another transparent base member formed of an acrylic material so that the optical element is held between the transparent base members.

3. The optical device of claim 2,
wherein the transparent base members are joined together with adhesive formed of an acrylic material.

4. The optical device of claim 3,
wherein the adhesive is of an ultraviolet-curing type.

5. The optical device of claim 1,
wherein the optical element is formed by bonding a hologram photosensitive material in an unexposed state to the transparent base member to be used during reproduction and then exposing the hologram photosensitive material to laser light.

6. The optical device of claim 1,
wherein the optical element is bonded to the transparent base member through a polymerization reaction that takes place in an exposure process in which an hologram photosensitive material is exposed to laser light and in a fixing process in which the hologram photosensitive material is fixed by being irradiated with light.

7. The optical device of claim 1,
wherein the transparent base member has a spectral transmittance of 10% or less at a wavelength of 360 nm.

8. The optical device of claim 1,
wherein the transparent base member has a spectral transmittance of 80% or more at a wavelength of 400 nm.

9. The optical device of claim 1,
wherein a deflection temperature under load of the transparent base member is set to be higher than or equal to a temperature that permits unreacted monomers in the hologram photosensitive material to diffuse and move within the hologram photosensitive material.

10. The optical device of claim 1,
wherein the optical element has a plurality of diffraction efficiency peaks corresponding to a plurality of different wavelengths, and a sum of diffraction efficiency values at the different wavelengths at which the diffraction efficiency peaks are located is 100% or more.

11. The optical device of claim 10,
wherein the different wavelengths are wavelengths corresponding to red, green, and blue, respectively.

12. The optical device of claim 10,
wherein a maximum diffraction efficiency value among the diffraction efficiency values at the different wavelengths at which the diffraction efficiency peaks are located is 70% or more.

13. An image display apparatus comprising:
an optical device; and
an image display element that displays an image to feed the image to the optical device,
the optical device comprising:
a transparent base member; and
an optical element formed as a hologram and bonded on the transparent base member,
wherein the optical element and the transparent base member are both formed of an acrylic material.

14. The image display apparatus of claim 13,
wherein the optical element included in the optical device is a volume-phase-type reflective hologram.

15. The image display apparatus of claim 13,
wherein the optical element included in the optical device is a combiner that directs to an observer's eye the image fed from the image display element and an outside-world image simultaneously.

16. The image display apparatus of claim 13,
wherein the optical device forms an eyepiece optical system that directs to an observer's eye an enlarged virtual image of the image displayed by the image display element.

17. The image display apparatus of claim 16,
wherein the eyepiece optical system has a non-axisymmetric optical power.

18. The image display apparatus of claim 13,
wherein the transparent base member included in the optical device totally reflects, within the transparent base member itself, light of the image fed from the image display element and thereby directs the light to the optical element.

19. The image display apparatus of claim 13,
wherein the optical element included in the optical device has a transmittance of 10% or more.

20. A head-mounted display comprising:
an image display apparatus; and
a supporter that supports the image display apparatus before an observer's eye,
the image display apparatus comprising:
an optical device; and
an image display element that displays an image to feed the image to the optical device,
the optical device comprising:
a transparent base member; and
an optical element formed as a hologram and bonded on the transparent base member,
wherein the optical element and the transparent base member are both formed of an acrylic material.
